(19) United States
(12) Patent Application Publication
(10) Pub. No.: US 2019/0350351 A1
(43) Pub. Date: Nov. 21, 2019

(54) SECURING APPARATUS FOR A CASE FOR AN ELECTRONIC DEVICE

(71) Applicant: CASE-MATE, INC., Atlanta, GA (US)

(72) Inventor: Saumil Chetan MODY, Atlanta, GA (US)

(73) Assignee: CASE-MATE, INC., Atlanta, GA (US)

(21) Appl. No.: 16/411,509

(22) Filed: May 14, 2019

Related U.S. Application Data
(60) Provisional application No. 62/672,675, filed on May 17, 2018.

(51) Int. Cl. A45F 5/10; B29C 65/48

(52) U.S. Cl. CPC A45F 5/10; B29L 2031/463; B29C 65/48

(57) ABSTRACT

A securing apparatus for a portable electronic device including an elastic strap secured between two cap assemblies. The cap assemblies include adhesive or other mounting elements to attach the assemblies to the electronic device such that the elastic strap forms an elastic handle or grip support.

### CROSS-REFERENCE TO RELATED APPLICATION

This application claims the benefit of U.S. Provisional Patent Application Ser. No. 62/672,675 filed May 17, 2018, the entirety of which is hereby incorporated herein by reference for all purposes.

### TECHNICAL FIELD

The present invention relates generally to the field of accessories for mobile devices, and more particularly to a holder or grip device for attachment to a mobile phone or other electronic device, for example by attachment to a protective case or cover installed on the electronic device, to allow its user to hold the electronic device more easily and securely.

### BACKGROUND

Some mobile phones and other portable electronic devices can be difficult to hold and operate in some applications. This may be particularly problematic with larger devices and in single-handed modes of use. Damage caused by dropping a mobile electronic device can be very expensive. Accordingly, it can be seen that needs exist for improvements for mobile devices to assist a user in providing a more convenient and secure hold of said devices.

It is to the provision of accessories and improvements for portable electronic devices meeting these and other needs that the present invention is primarily directed.

### SUMMARY

In example embodiments, the present invention provides accessories and improvements for portable electronic devices to assist a user in securely holding said devices. In particular, the invention provides a holding or support accessory for a portable electronic device including a strap and a plurality of cap assemblies with adhesive or other attachment means, and optionally including decorative elements.

In one aspect, the present invention relates to a securing apparatus for a portable electronic device. The securing apparatus includes a strap element with two ends. The securing apparatus further includes a cap assembly secured to each end of the strap element. The cap assemblies have adhesive mounting elements configured to attach the cap assemblies to the portable electronic device, for example by attachment to a protective case or cover installed onto the electronic device.

In another aspect, the invention relates to a support attachment for portable electronic devices. The support attachment includes an elongated elastic band, a plurality of bottom caps, a plurality of top caps, and a plurality of adhesive elements configured for securing the bottom caps to the portable electronic devices. The elastic band has a distal end and a proximal end. The bottom cap includes at least one female clasp element and a recessed portion for receiving the ends of the elastic band. The top cap includes at least one male clasp element and a recessed portion for receiving the ends of the elastic band. The top and bottom bands are configured to clasp together and securely hold the ends of the elastic band. When the support attachment is attached to a portable electronic device, the elastic band defines a handle or support for the user's hand for a more convenient and secure hold of the device.

In still another aspect, the invention relates to a method of modifying a portable electronic device to assist a user in holding said device. The method preferably includes attaching a support accessory to the portable electronic device, the support accessory having an elongated strap with a distal end and a proximal end and two cap assemblies coupled to the distal and proximal ends of the strap. The cap assemblies also include adhesive elements configured for attachment to the portable electronic device. When the cap assemblies are attached to the portable electronic device, the strap bridging the cap assemblies defines a backstop or handle configured to provide support to the user's hand while holding said device.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIG. 1 is a perspective view of a securing apparatus attached to a back panel of a phone case according to an example embodiment of the present invention.

FIGS. 2A-2C show the securing apparatus of FIG. 1 in various orientations of use.

FIG. 3 is a perspective view of the securing apparatus of FIG. 1.

FIG. 4 is a side cross-sectional view of the securing apparatus of FIG. 3.

FIG. 5 is an exploded or assembly view of the securing apparatus of FIG. 3.

FIG. 6 is a perspective view of a bottom cap of the securing apparatus of FIG. 5.

FIG. 7 is an exploded or assembly view of the bottom cap of FIG. 6 and a strap according to an example embodiment of the present invention.

FIG. 8 is a perspective view of a top cap of the securing apparatus of FIG. 5.

FIG. 9 is an assembly view of the bottom cap-strap assembly of FIG. 7 and the top cap of FIG. 8.

FIGS. 10A-10C show detailed sectional views of the bottom cap-strap-top cap assembly of FIG. 9.

FIG. 11 is an exploded or assembly view of the assembly of FIG. 9, a top cap adhesive, and a decorative insert.

FIG. 12 is an exploded or assembly view of the assembly of FIG. 11 and a bottom cap adhesive.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

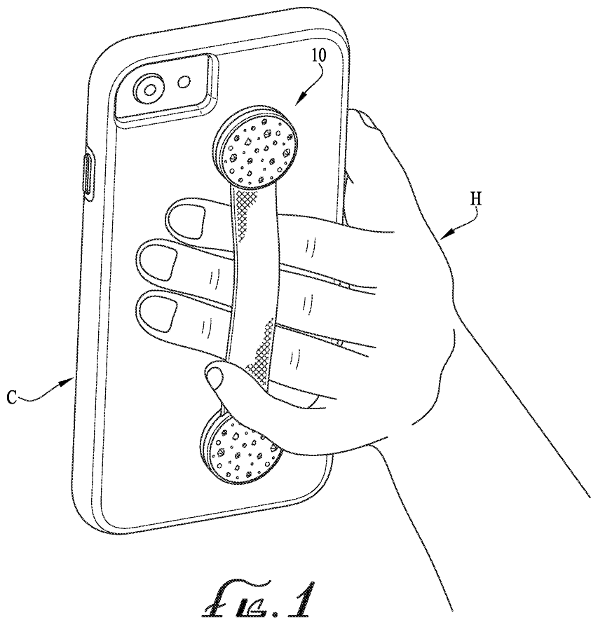

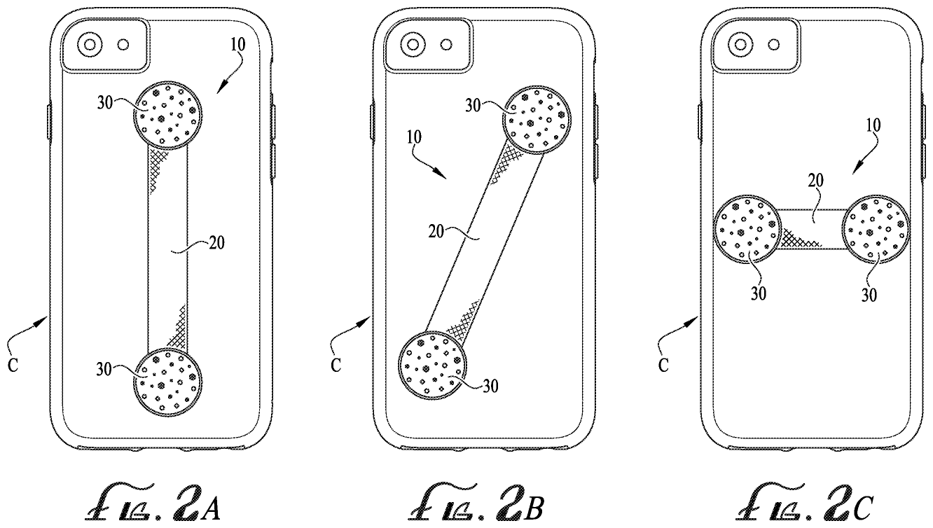

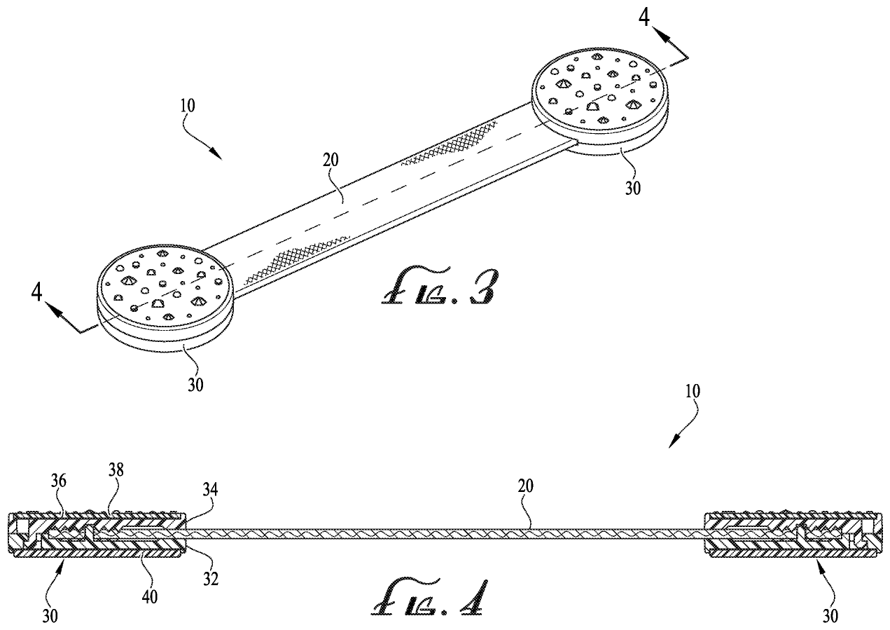

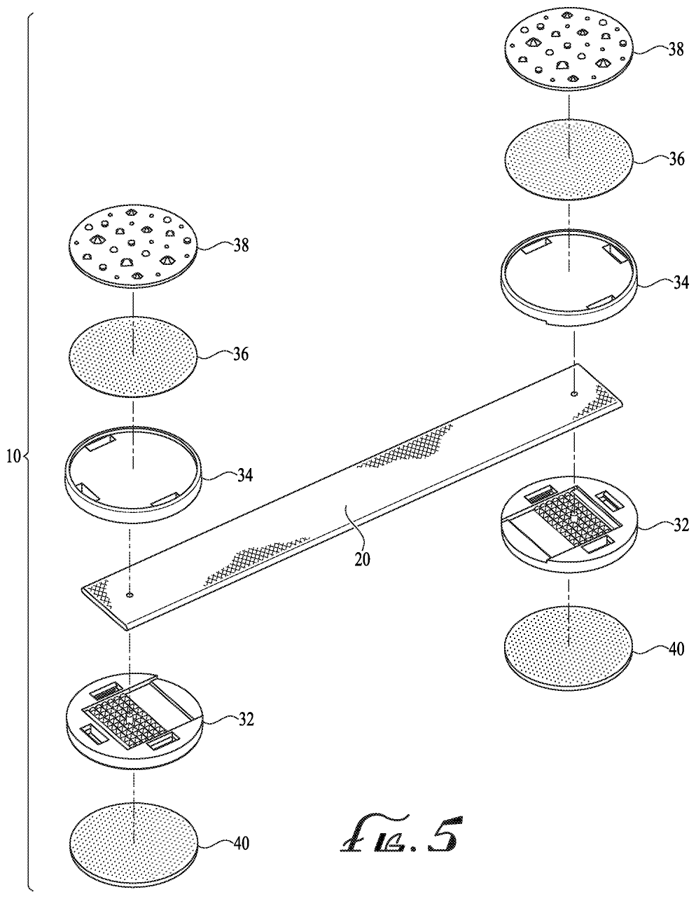

With reference now to the drawing figures, wherein like reference numbers represent corresponding parts throughout the several views, FIGS. 1-3 generally show a securing apparatus or harness 10 for mobile phones and phone cases. FIG. 1 shows the securing harness 10 affixed to the back exterior of a phone case C according to an example embodiment of the present invention. In example modes of use, the securing apparatus 10 is attached to the exterior of a phone case C, or phone, and provides the user H with additional support while handling the phone. The securing apparatus 10 may be arranged in a variety of orientations including, but not limited to, the orientations as shown in FIGS. 2A-C. In other example modes of use, the securing apparatus 10 is configured to provide additional support for holding tablet computers, music and/or video players, electronic readers, handheld game devices, or other portable devices. As shown in FIGS. 4 and 5, securing harness 10 generally comprises a band or strap 20, a cap assembly 30, a top adhesive or tape 36, a decorative insert or layer 38, and a bottom adhesive or tape 40. The cap assembly 30 generally comprises a bottom cap or cover 32 and a top cap or cover 34.

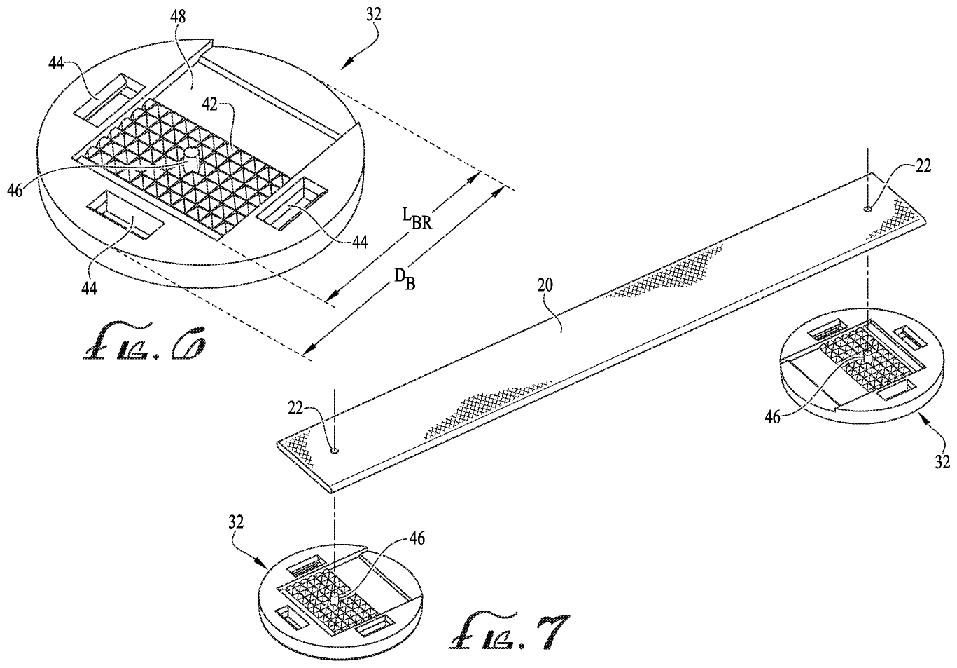

In example embodiments, the bottom cap 32 is generally a polycarbonate circular disk with a diameter between 0.5-1.5 inches, preferably between 0.75-1.25 inches, and more preferably between 0.8-1 inches, and a thickness between 0.05-0.2 inches, preferably between 0.07-0.15 inches, and more preferably between 0.09-0.1 inches. The bottom cap 32 has a top face and a bottom face. The top face of the bottom cap 32 comprises a bottom recess or depression 48 extending substantially inward from one edge of the bottom cap to its opposite edge, as shown in FIGS. 6 and 7. In example embodiments, the bottom recess 48 has a length L_{BR} about 60%-85%, and preferably 75%-85%, of the diameter D_{B}, and has a width large enough to receive or seat the ends of the band or strap 20. The bottom recess 48 comprises a knurled portion or surface 42 configured to engage a portion of the strap 20 and a reciprocally knurled portion 52 of the top cap 34. The bottom cap further comprises a positioning pin or peg 46 configured to locate and anchor the strap 20 about the pin 46, as shown in FIG. 7. In example embodiments, the bottom cap 32 also comprises at least one snap-fit slot or retainer 44 configured to receive and engage a cooperative snap-fit hook 54 of the top cap or cover 34. In the depicted embodiment, the bottom cap has three snap-fit slots 44 spaced about the center recess 48. In alternate embodiments, the bottom cap 32 may comprise other profiles, such as squares, triangles, stars, or other geometric shapes, and may be formed from metals, rubbers, other thermoplastic polymers, and/or natural or synthetic materials or combinations thereof.

In example embodiments, the strap or band 20 comprises a polyester coating or layer over an internal spandex elastic material. In alternate embodiments, the strap or band 20 comprises nylon webbing, fabric, cord, strapping, or other flexible material(s). The strap 20 has an elongate profile with a length between its distal and proximal ends. According to the example embodiment, the length of the strap is between 3-4.5 inches, preferably 3.5-4 inches, and more preferably 3.75-3.80 inches. However, the length of the strap 20 may vary depending on the size of the device C on which the securing apparatus 10 is to be attached. As shown in FIG. 7, strap 20 further comprises positioning holes or voids 22 near its distal and proximal ends, wherein the holes 22 are configured to engage the positioning pins 46 of bottom caps 32. According to the example embodiment, each end of strap 20 is positioned over a bottom cap 32 such that the ends of the strap 20 are at least partially nested within the bottom recesses 48 and over the knurled surfaces 42 of the bottom caps 32. In alternate embodiments, band 20 may comprise rubbers, nylons and/or other elastic fabrics, elastomeric polymers, and/or other natural or synthetic elastic materials or combinations thereof. Optionally, the strap or band 20 is provided in a longer length that a user can cut to a desired length for their preferred application, and/or may be adjustable in length.

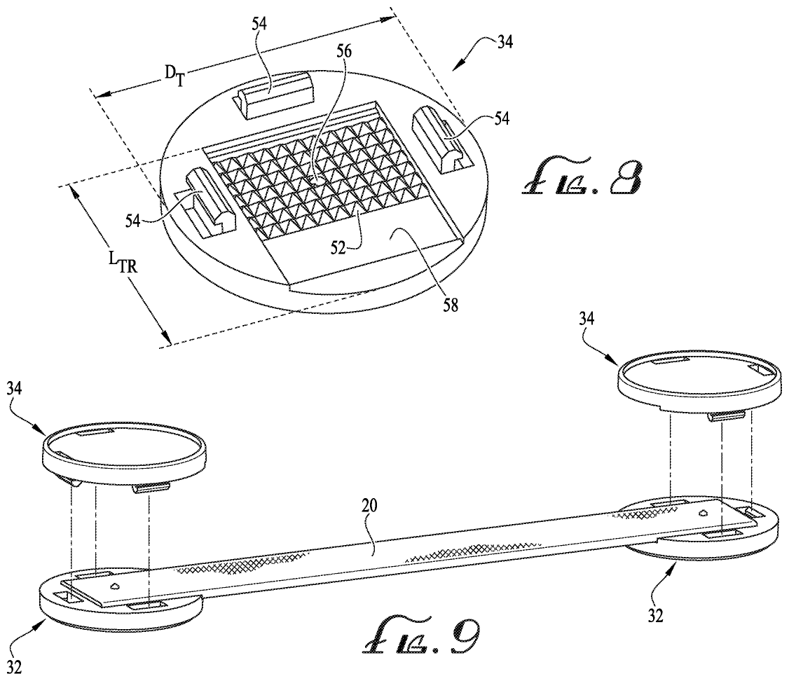

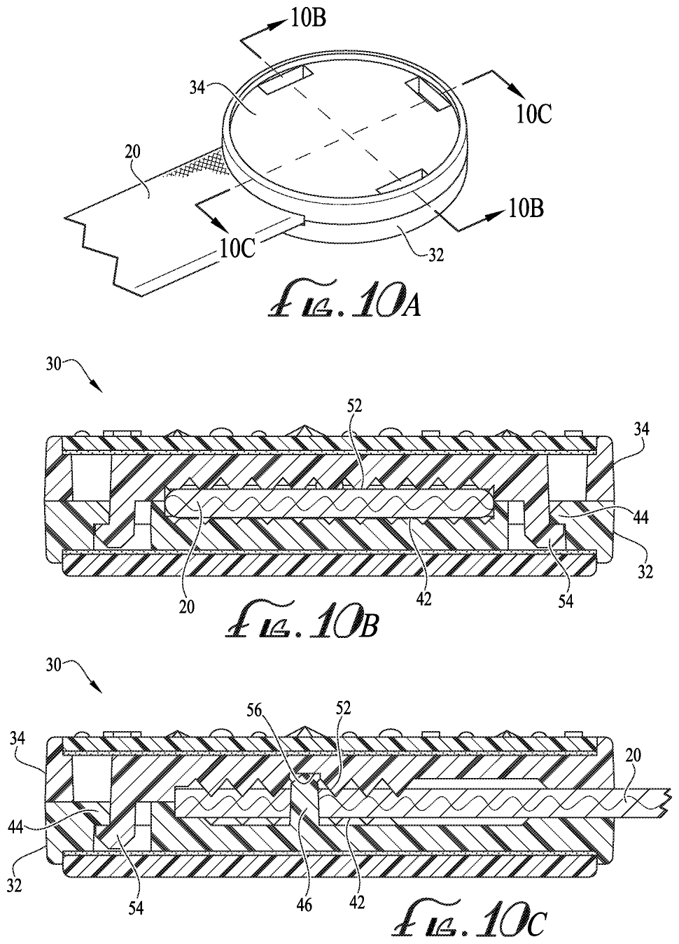

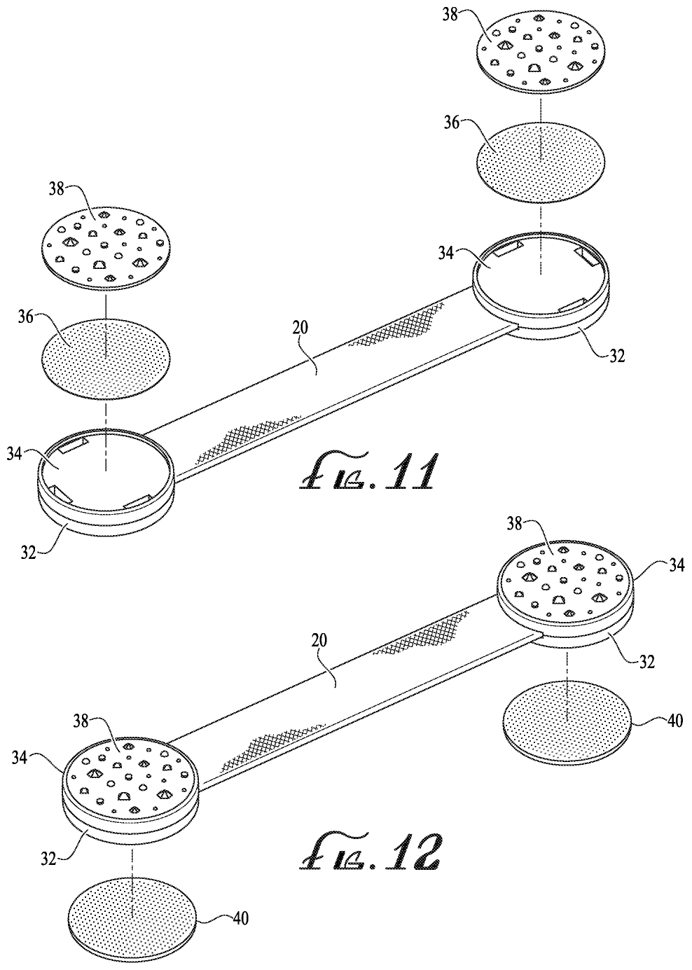

According to the example embodiment, the top cap 34 is generally a polycarbonate circular disk with a diameter between 0.5-1.5 inches, preferably between 0.75-1.25 inches, and more preferably between 0.8-1 inches and a thickness between 0.05-0.2 inches, preferably between 0.07-0.15 inches, and more preferably between 0.09-0.1 inches. The top cap 34 has a top face and a bottom face. The bottom face of the top cap 34 comprises a top recess or depression 58 extending substantially inward from one edge of the top cap towards its opposite edge, as shown in FIG. 8. In the example embodiment, the top recess 58 has a length L_{TR} about 60%-85% of the diameter D_{T}, preferably 75%-85%, and has a width large enough to receive or seat the ends of the band or strap 20. The top recess 58 comprises a knurled portion or surface 52 configured for cooperative engagement with the knurled portion 42 of the bottom cap 34 and to effectively grip the band 20 between the top and bottom caps 32, 34. The top cap 34 further comprises a positioning pin hole or cavity 56 configured to receive a portion of the positioning pin 46 of the bottom cap 32. In example embodiments, the top cap 32 also comprises at least one snap-fit hook or catch 54 configured for cooperative engagement with the snap-fit slot(s) 44 of the bottom cover 32. In the depicted embodiment, three snap-fit hooks 54 are aligned about the top recess 58 for engaging the three snap-fit slots 44 of the bottom cap 32, as shown in FIGS. 9 and 10A-C. In example modes of use, each end of strap 20 are securely compressed or sandwiched between bottom and top caps 32, 34. In alternate embodiments, the top cap 34 may comprise other profiles, such as squares, triangles, stars, or other geometric shapes, and may be formed from metals, rubbers, other thermoplastic polymers, and/or natural or synthetic materials or combinations thereof.

In some example embodiments, the knurled surface 42 and/or positioning pin 46 of the bottom cover 32 may be supplemented with adhesives. In other example embodiments, the knurled surface 42 and/or positioning pin 46 are absent altogether and adhesives may be utilized to secure the strap ends between the bottom and top recesses 48, 58. In yet another example embodiment, caps 32 and 34 may comprise recesses 48 and 58 without knurled portions and configured to grip the strap 20 between the caps 32 and 34 substantially by pressure and friction. In further example embodiments, the bottom and top caps 32, 34 may be secured together by means of hook-and-loop fasteners, adhesives, and/or other clasp mechanisms.

In example embodiments, decorative inserts or layers 38 are attached to the top face of the top cap 34 using a double-sided tape or adhesive 36, such as 3M VHB™ or other permanent or semi-permanent adhesive. A decorative insert 38 comprises a top face and a bottom face, wherein the top face may be embellished with decorative elements, such as glitters, gems, rhinestones, and graphics. In other embodiments, the decorative insert 38 is self-adhesive wherein the top face comprises decorative elements and the bottom face comprises an adhesive.

In example embodiments, the bottom cap adhesive or sticker 40 is a double-sided tape, such as 3M VHB™. The bottom cap adhesive 40 generally has a top face and a bottom face. The top face of the bottom cap sticker 40 is affixed to the bottom face of the bottom cap 32. The bottom face of the sticker 40 comprises a removable film which shields the bottom adhesive surface until the securing apparatus is ready to be used. In alternate embodiments, the bottom cap sticker 40 may comprise a magnetic bottom surface for attaching the securing apparatus 10 to devices made of ferromagnetic metals or ferromagnetic plate attachments for portable devices. In other embodiments, the bottom cap sticker 40 may be a removable adhesive, such as 3M Scotch Command™ Removable Adhesive. In yet another example embodiment, hook-and-loop fasteners or tapes may be utilized in place of the bottom sticker 40.

In example mode of use, the securing apparatus 10 is affixed to the back exterior of a phone case by, first, removing the protective films from the bottom faces of the bottom cap stickers 40. The user, then, secures the two cap assemblies 30 to the phone case in a user desired orientation by means of the now exposed bottom cap adhesives 40. Preferably, the user orients the two cap assemblies such that the strap 20 is taut enough to provide pressure and support to the user's fingers or hand during use. However, the cap assemblies 30 may be affixed to the user's device to create loops or in any manner desired by the user. The securing apparatus 10 may be attached to a case installed on the electronic device, or alternatively may be attached directly to the electronic device, for example on the back panel of the device housing.

While the invention has been described with reference to example embodiments, it will be understood by those skilled in the art that a variety of modifications, additions and deletions are within the scope of the invention, as defined by the following claims.

What is claimed is:

1. A securing apparatus for a portable electronic device, comprising:
a strap having two ends, and
a cap assembly secured to each of the two ends of the strap, the cap assemblies comprising mounting elements for securing the cap assemblies to the portable electronic device.

2. The securing apparatus of claim 1, wherein the cap assembly comprises a bottom cap and a top cap.

3. The securing apparatus of claim 2, wherein the bottom cap and top cap comprise at least one cooperative clasp mechanisms for securing the top cap to the bottom cap.

4. The securing apparatus of claim 2, wherein the bottom cap and top cap comprise recesses for receiving the strap.

5. The securing apparatus of claim 4, wherein the recesses comprise knurled surfaces.

6. The securing apparatus of claim 1, further comprising decorative elements.

7. The securing apparatus of claim 1, wherein the strap is elastic.

8. The securing apparatus of claim 1, wherein the mounting elements comprise adhesive mounting elements.

9. A support attachment for portable electronic devices, the support attachment comprising,
an elongated elastic band having a distal end and a proximal end;
a plurality of bottom caps comprising at least one female clasp element and a first recess for receiving either the distal or proximal ends of the elastic band;
a plurality of top caps comprising at least one male clasp element and a second recess for receiving either the distal or proximal ends of the elastic bands; and
a plurality of adhesive elements configured for securing the bottom caps to the portable electronic devices,
wherein each end of the elastic band is configured to be secured between the first recess of the bottom cap and the second recess of the top cap, and
wherein the at least one male clasp element of the top cap is configured to engage the at least one female clasp element of the bottom cap, wherein the engagement of the bottom and top caps pinches the elastic band between the bottom and top caps preventing dislodgement of the elastic band.

10. The support attachment for portable electronic devices of claim 9, wherein the first and second recesses comprise knurled sections configured for cooperative engagement.

11. The support attachment for portable electronic devices of claim 9, wherein the elastic band comprises a positioning hole near each of its distal and proximal ends, and wherein the first recess of the bottom cap comprises a peg configured to engage the positioning hole.

12. The support attachment for portable electronic devices of claim 9, further comprising decorative elements.

13. A method of modifying a portable electronic device to assist a user in holding the portable electronic device, the method comprising attaching a support accessory to the portable electronic device, the support accessory comprising an elongated elastic strap having a distal end and a proximal end and two cap assemblies coupled to the distal and proximal ends, the cap assemblies having adhesive elements configured for attachment to the portable electronic device, and the strap defining a backstop configured to provide support to a user's hand while handling the electronic device.

14. The method of claim 13, wherein the support accessory is secured to a back panel of the portable electronic device.

15. The method of claim 14, further comprising installing a case on the portable electronic device, and wherein the support accessory is attached to a back panel of the case.
